(19) United States
(12) Patent Application Publication
(10) Pub. No.: US 2024/0206652 A1
(43) Pub. Date: Jun. 27, 2024

(54) HANGING PLANTER SYSTEM

(71) Applicant: Patricia Harlan, Farmersville, CA (US)

(72) Inventor: Patricia Harlan, Farmersville, CA (US)

(21) Appl. No.: 18/086,120

(22) Filed: Dec. 21, 2022

(51) Int. Cl. A47G 7/04; A01G 9/02; H04R 1/02

(52) U.S. Cl. CPC A47G 7/044; A01G 9/023; H04R 1/028; H04R 2420/07

(57) ABSTRACT

A hanging planter system for hanging planter boxes on a wall includes a mounting structure being configured to support planters on a wall member. A sound emitter is coupled to the mounting structure which selectively emits sound. A planter box is coupled to the mounting structure.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to wall hanging planters and more particularly pertains to a new wall hanging planter for hanging planter boxes on a wall.

### (2) Description of Related Art Including Information Disclosed Under 37 CFR 1.97 and 1.98

The prior art relates to wall hanging planters which mount receptacles on a wall or fence for holding plants using a variety of structures including ones that implement irrigation systems.

### BRIEF SUMMARY OF THE INVENTION

An embodiment of the disclosure meets the needs presented above by generally comprising a mounting structure being configured to support planters on a wall member. A sound emitter is coupled to the mounting structure which selectively emits sound. A planter box is coupled to the mounting structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a hanging planter system according to an embodiment of the disclosure.

FIG. 2 is a front view of an embodiment of the disclosure.

FIG. 3 is a side view of an embodiment of the disclosure.

FIG. 4 is a cross-sectional in-use view of an embodiment of the disclosure from arrows 4-4 in FIG. 2.

FIG. 5 is a cross-sectional view of an embodiment of the disclosure from arrows 5-5 in FIG. 2.

FIG. 6 is a top front side perspective in-use view of an embodiment of the disclosure.

### DETAILED DESCRIPTION OF THE INVENTION

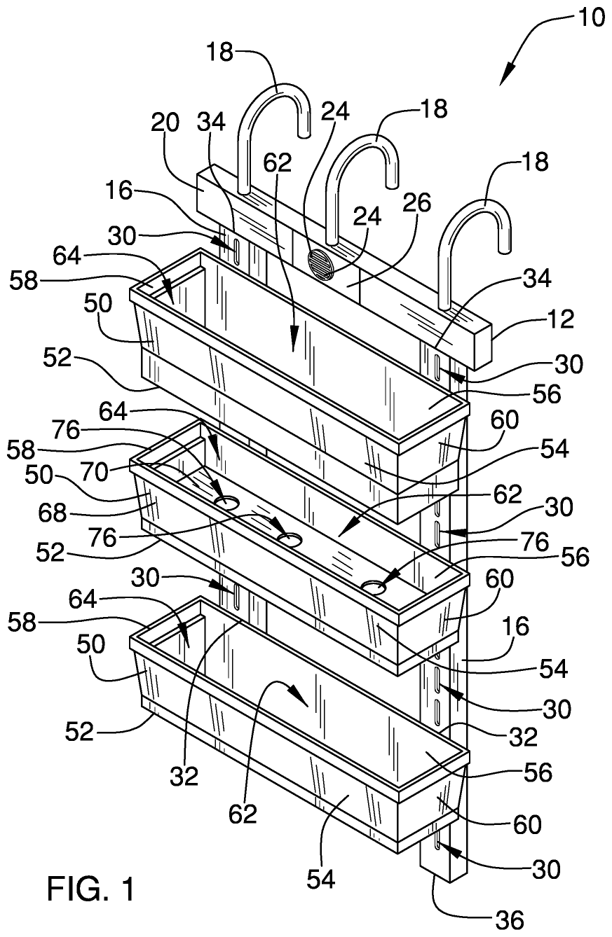

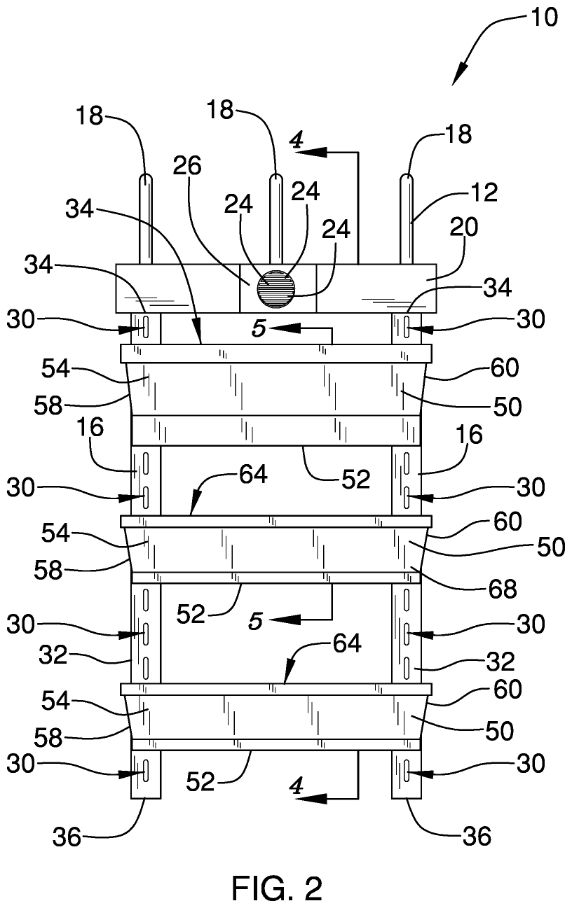

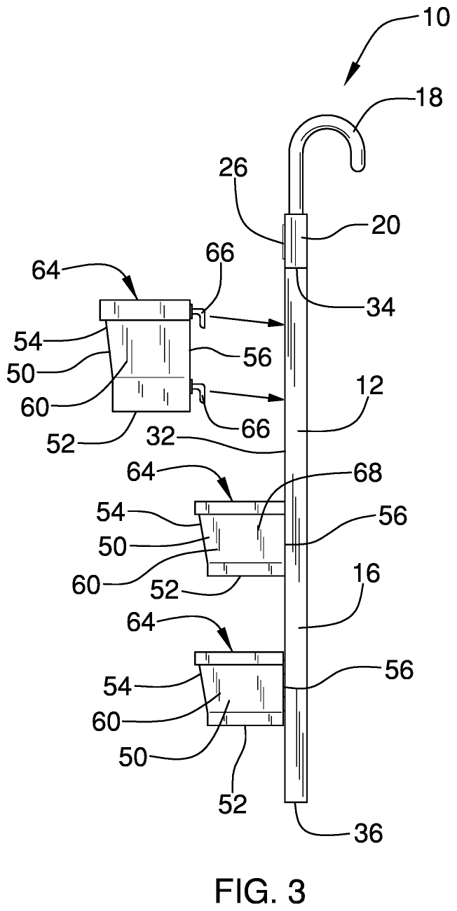

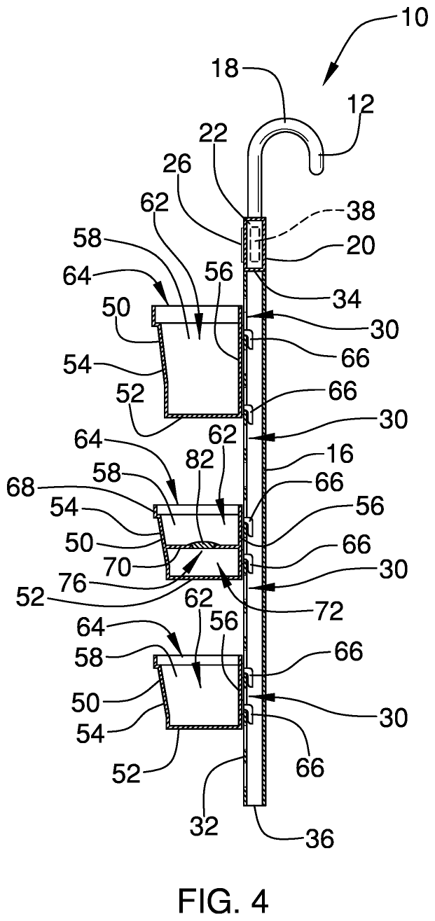

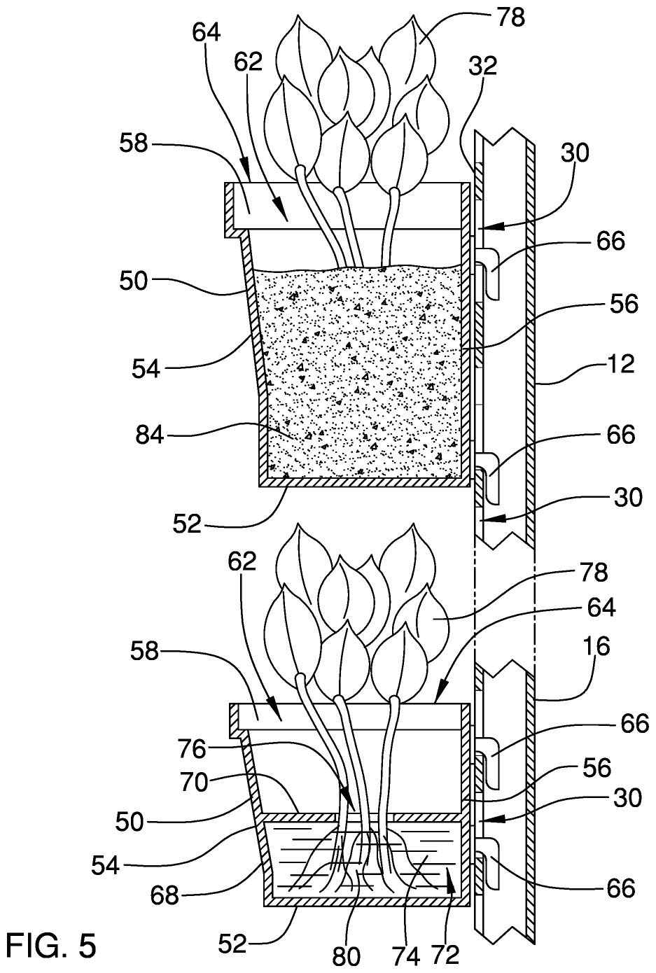

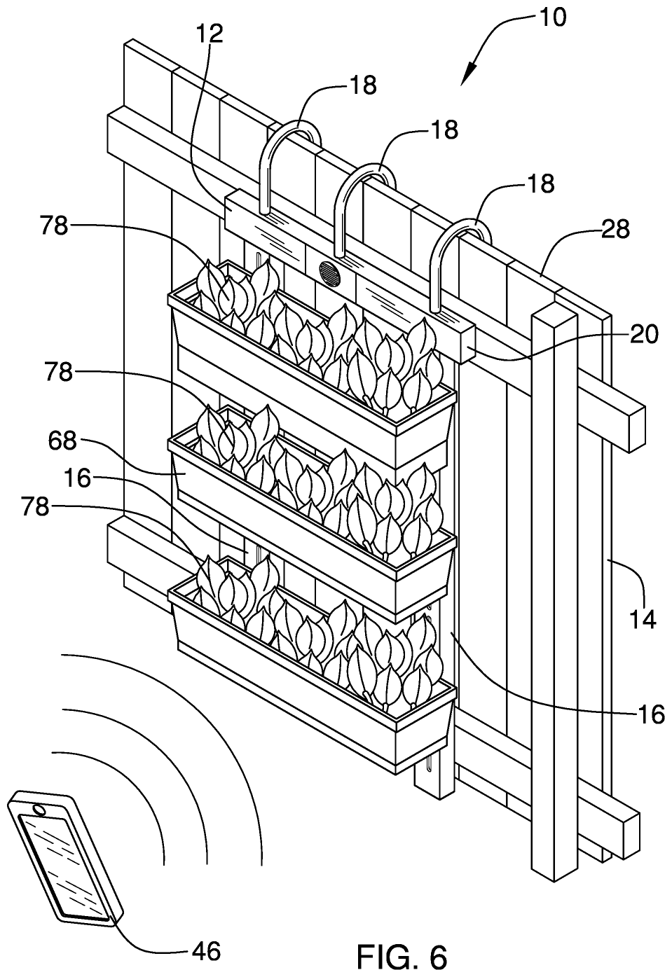

With reference now to the drawings, and in particular to FIGS. 1 through 6 thereof, a new wall hanging planter embodying the principles and concepts of an embodiment of the disclosure and generally designated by the reference numeral 10 will be described.

As best illustrated in FIGS. 1 through 6, the hanging planter system 10 generally comprises a mounting structure 12 being configured to support planters on a wall member 14. The mounting structure 12 comprises at least one support 16, at least one mounting hook 18, and an attachment member 20 being coupled to each of the at least one support 16 and the at least one mounting hook 18. The attachment member 20 also has a chamber 22 being positioned therein and at least one aperture 24 extending into a front side 26 of the attachment member 20 into the chamber 22 for permitting sound therethrough. The at least one mounting hook 18 extends upwardly and rearwardly from the attachment member 20 and is configured for engaging a top edge 28 of the wall member 14. “Wall member” as used in this description and the claims includes a fence, a door, railing or the like. The at least one support 16 extends downwardly from the attachment member 20. The at least one support 16 may have a plurality of slots 30 extending into a front surface 32 of the support 16 which is distributed evenly between a proximal end 34 and a distal end 36 of the at least one support 16 relative to the attachment member 20.

A sound emitter 38 is coupled to the mounting structure 12 and is positioned within the chamber 22. The sound emitter 38 selectively emits sound and is positioned to emit sound through the at least one aperture 24. The sound emitter 38 comprises a control circuit and an audio speaker being electrically coupled to the control circuit. The sound emitter 38 may also comprise a transceiver being electrically coupled to the control circuit for wirelessly receiving an audio signal for the sound emitter 38 to play via the audio speaker. The sound emitter 38 may also have a memory for storing audio files for playing via the audio speaker and may have a port for electrically receiving the audio files. The sound emitter 38 may have an integrated power source, such as a battery, or be powered from an external power source. In embodiments with a transceiver, a personal media player 46 is configured to selectively wirelessly transmit audible media to the sound emitter 38. The personal media player 46 may be a cell phone, computer, tablet, dedicated electronic audio player, or the like. The sound emitter 38 may also have an input for selecting and playing an audio file or selecting a source from which to receive an audio signal to play. Or the transceiver may be programmed to receive commands from the personal media player 46 for selecting and playing an audio file or playing the audio signal from the personal media player 46. The sound emitter 38 may be considered a conventional Bluetooth speaker.

At least one planter box 48 is coupled to the at least one support 16 and comprises a perimeter wall 50 coupled to and extending upwardly from a base wall 52. The perimeter wall 50 includes a front wall 54, a back wall 56, a first lateral wall 58, and a second lateral wall 60. The base wall 52 and the perimeter wall 50 collectively partially enclose an interior space 62, and the at least one planter box 48 has a top side 64 that is open to the interior space 62. In some embodiments, the at least one planter box 48 may be releasably mounted to the at least one support 16. In these embodiments, the at least one planter box 48 may further comprise at least one box hook 66 which is coupled to the back wall 56. The at least one box hook 66 extends backwardly and downwardly from the back wall 56 and is receivable into a selectable one of the slots 30 of the at least one support 16 to mount the at least one planter box 48 to the at least one support 16. Alternatively, threaded fasteners, clamps, latches, or other like connectors may be used to mount the at least one planter box 48 to the at least one support 16.

The at least one planter box 48 may include a water 74 rooting box 68, which includes a divider 70 extending between the front wall 54 and the back wall 56 and between the first lateral wall 58 and the second lateral wall 60. The divider 70 is spaced above the base wall 52. The divider 70, the base wall 52, and the perimeter wall 50 collectively form a reservoir 72 for holding water 74. The divider 70 has at least one hole 76 extending therethrough into the reservoir 72 so that a plant 78 can be inserted through the hole 76 such that roots 80 of the plant 78 contact the water 74 in the reservoir 72 and the plant 78 is able to grow upwardly from the hole 76. At least one cap 82 complementary in shape to the at least one hole 76 may be included which is positionable in a closed position covering the at least one hole 76 and in an open position exposing the at least one hole 76.

In use, the mounting structure 12 is mounted on the wall member 14 such that the at least one box hook 66 engages the top edge 28 of the wall member 14. In embodiments where the planter boxes 48 are releasably mountable to the mounting structure 12, the planter boxes 48 are attached to the mounting structure 12. The planter boxes 48 may be filled with dirt 84 and plants 78. In embodiments including a water 74 rooting box 68, water 74 is added to the reservoir 72 through the at least one hole 76 in the divider 70 and a plant 78 is inserted into the hole 76 such that the roots 80 of the plant 78 contact the water 74 in the reservoir 72. The divider 70 may support the plant 78 to remain upright. Multiple plants 78 may each be placed in a selectable one of a plurality of holes 76. If there are holes 76 that do not contain a plant 78, the cap 82 associated with the hole 76 may be positioned in the closed position to cover the hole 76. The sound emitter 38 may then be operated to play audio files or audio signals via the audio speaker.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hanging planter system comprising:
a mounting structure being configured to support planters on a wall member;
a sound emitter being coupled to the mounting structure, the sound emitter selectively emitting sound; and
a planter box being coupled to the mounting structure.

2. The system of claim 1, wherein the mounting structure comprises:
an attachment member;
at least one mounting hook extending upwardly and rearwardly from the attachment member, the at least one mounting hook being configured for engaging a top edge of the wall member; and
at least one support being coupled to and extending downwardly from the attachment member, the planter box being mounted to the at least one support.

3. The system of claim 2, wherein the attachment member has a chamber being positioned therein, the attachment member having at least one aperture extending into a front side of the attachment member and into the chamber for permitting sound therethrough, the sound emitter being positioned within the chamber, the sound emitter being positioned for emitting sound through the at least one aperture.

4. The system of claim 1, further comprising a personal media player being configured to selectively wirelessly transmit audible media to the sound emitter, the sound emitter comprising a control circuit, an audio speaker being electrically coupled to the control circuit, and a transceiver being electrically coupled to the control circuit.

5. The system of claim 2, wherein the planter box is one of a plurality of planter boxes being releasably mounted to the at least one support.

6. The system of claim 5, wherein the at least one support has a plurality of slots extending into a front surface of the support, each of the plurality of planter boxes comprising:
a base wall;
a perimeter wall extending upwardly from the base wall, the perimeter wall including a front wall, a back wall, a first lateral wall, and a second lateral wall, the base wall and the perimeter wall collectively partially enclosing an interior space, each of the plurality of planter boxes having a top side being open to the interior space; and
at least one box hook being coupled to the back wall, the at least one box hook extending backwardly and downwardly from the back wall, each of the plurality of planter boxes being mounted to the at least one support wherein a selectable one of the slots receives one of the hooks.

7. The system of claim 6, wherein the plurality of slots being distributed between a proximal end and a distal end of the at least one support relative to the attachment member, the plurality of slots being evenly spaced from each other.

8. The system of claim 1, wherein the planter box defines a water rooting box, the water rooting box comprising:
a base wall;
a perimeter wall extending upwardly from the base wall, the perimeter wall including a front wall, a back wall, a first lateral wall, and a second lateral wall, the base wall and the perimeter wall collectively partially enclosing an interior space, each of the plurality of planter boxes having a top side being open to the interior space; and
a divider extending between the front wall and the back wall and between the first lateral wall and the second lateral wall, the divider being spaced above the base wall, each of the divider, the base wall, and the perimeter wall collectively forming a reservoir for holding water, the divider having at least one hole extending therethrough into the reservoir.

9. The system of claim 8, wherein the water rooting box further comprises at least one cap being complementary in shape to the at least one hole, the at least one cap being positionable in a closed position covering the at least one hole and in an open position exposing the at least one hole.

10. The system of claim 5, wherein at least one of the plurality of planter boxes defines at least one water rooting box, the at least one water rooting box comprising:
a base wall;
a perimeter wall extending upwardly from the base wall, the perimeter wall including a front wall, a back wall, a first lateral wall, and a second lateral wall, the base wall and the perimeter wall collectively partially enclosing an interior space, each of the plurality of planter boxes having a top side being open to the interior space; and
a divider extending between the front wall and the back wall and between the first lateral wall and the second lateral wall, the divider being spaced above the base wall, each of the divider, the base wall, and the perimeter wall collectively forming a reservoir for holding water, the divider having at least one hole extending therethrough into the reservoir.

11. The system of claim 10, wherein the at least one water rooting box further comprises at least one cap being complementary in shape to the at least one hole, the at least one cap being positionable in a closed position covering the at least one hole and in an open position exposing the at least one hole.

12. A hanging planter system comprising:
a mounting structure being configured to support planters on a wall member, the mounting structure comprising:
an attachment member having a chamber being positioned therein, the attachment member having at least one aperture extending into a front side of the attachment member and into the chamber for permitting sound therethrough;
at least one mounting hook extending upwardly and rearwardly from the attachment member, the at least one mounting hook being configured for engaging a top edge of the wall member; and
at least one support being coupled to and extending downwardly from the attachment member, the at least one support having a plurality of slots extending into a front surface of the support, the plurality of slots being distributed between a proximal end and a distal end of the at least one support relative to the attachment member, the plurality of slots being evenly spaced from each other;
a sound emitter being coupled to the mounting structure, the sound emitter being positioned within the chamber of the attachment member, the sound emitter selectively emitting sound through the at least one aperture, the sound emitter comprising a control circuit, an audio speaker being electrically coupled to the control circuit, and a transceiver being electrically coupled to the control circuit;
a personal media player being configured to selectively wirelessly transmit audible media to the sound emitter;
a plurality of planter boxes being coupled to the mounting structure, each of the plurality of planter boxes being releasably mounted to the at least one support, each of the plurality of planter boxes comprising:
a base wall;
a perimeter wall extending upwardly from the base wall, the perimeter wall including a front wall, a back wall, a first lateral wall, and a second lateral wall, the base wall and the perimeter wall collectively partially enclosing an interior space, each of the plurality of planter boxes having a top side being open to the interior space; and
at least one box hook being coupled to the back wall, the at least one box hook extending backwardly and downwardly from the back wall, each of the plurality of planter boxes being mounted to the at least one support wherein a selectable one of the slots receives one of the hooks; and
at least one of the plurality of planter boxes defining a water rooting box, the at least one water rooting box comprising:
a divider extending between the front wall and the back wall and between the first lateral wall and the second lateral wall, the divider being spaced above the base wall, each of the divider, the base wall, and the perimeter wall collectively forming a reservoir for holding water, the divider having at least one hole extending therethrough into the reservoir; and
at least one cap being complementary in shape to the at least one hole, the at least one cap being positionable in a closed position covering the at least one hole and in an open position exposing the at least one hole.
